(19) United States
(12) Patent Application Publication
(10) Pub. No.: US 2011/0289041 A1
(43) Pub. Date: Nov. 24, 2011

(54) SYSTEMS AND METHODS FOR MANAGING ASSIGNMENT TEMPLATES

(75) Inventors: Phillip E. Hunt, Kenmore, WA (US); James R. Stout, Timonium, MD (US); Breck Ruppelius, Montgomery, TX (US)

(73) Assignee: AVANADE HOLDINGS, LLC, Seattle, WA (US)

(21) Appl. No.: 13/112,974

(22) Filed: May 20, 2011

Related U.S. Application Data
(60) Provisional application No. 61/347,290, filed on May 21, 2010.

(51) Int. Cl. G06N 5/02; G06F 17/30

(52) U.S. Cl. 706/50; 707/802; 707/E17.044

(57) ABSTRACT

The present disclosure relates to management of information and relationships. In an embodiment, a management device can include a computer memory configured to store a set of tasks and a set of assignment templates. The management device can further include a processor configured to retrieve a task of the set of tasks and an assignment template of the set of assignment templates, parse the contents of the assignment template, and assign the task to a set of users based on the parsed contents of the assignment template. The assignment of the task to the set of users may include loading the contents of the assignment template into a data structure that stores the task. Additionally, the assignment of the task to the set of users can include linking the assignment template to the data structure that stores the task. The format of the data structures may include extensible markup language.

### BACKGROUND

The present disclosure generally relates to managing relationships and information. More specifically, the present disclosure relates to systems and devices which automate processes for relationship and information management.

Generally described, extended relationship management (XRM) systems may be used to manage different types of relationships and information. For example, XRM software may include customer relationship management (CRM) software to manage, automate, organize, and/or synchronize processes related to customer service, sales, and technical support. CRM software may be used to improve marketing, dealings with clients, and sales in a business context, for example. In addition to managing relationships with customers, XRM software may also be used to manage information or relationships with investors, partners, press, media, supply chain, human resources, and/or contacts.

### SUMMARY

Unfortunately, conventional XRM and enterprise resource planning (ERP) systems can be inefficient with respect to automating tasking, workflows, and/or approvals, for example. In some environments, it may be desirous to enable an individual, organization, enterprise, and/or government entity or agency to collect, share, and manage information about people, money, products, and services and to track and leverage the activities related to them and the relationships among them. For example, an organization may wish to plan work schedules and workflows by distributing tasks. The process of distributing tasks may include tasking or delegating persons, users, or various groups to a particular responsibility or activity.

The process of selecting personnel to assign to particular tasks and coordinating the level of responsibility of the selected personnel with respect to the assignment can be expensive and inconvenient. Because of its manual nature, the assignment of tasks can be repetitive and time consuming. Software and hardware systems for XRM are often ineffective because of these and other shortcomings. Accordingly, methods, systems, and devices for automating the creation of tasks and assigning users to tasks are disclosed.

In one embodiment, a computer-implemented method is provided. The method may include receiving as a first input a selection of a plurality of users to assign to a list; receiving as a second input a selection of a level of responsibility to associate with the respective plurality of users; and storing the first and second inputs in a data structure. The method may also include linking the data structure to a plurality of tasks. The plurality of tasks may include activities to be completed by a group of individuals or organizations. The method may further include retrieving the data structure from storage and automatically assigning the plurality of users to a first task with the associated level of responsibility based on the data structure. The level of responsibility may include a first level of primary responsibility or a second level of secondary responsibility. The data structure may be stored in a format including extensible markup language.

In another aspect, a computing device is provided. The device may include a computer memory configured to store a set of tasks and a set of assignment templates; and a processor configured to retrieve a first task of the set of tasks and a first assignment template of the set of assignment templates, parse the contents of the first assignment template, and assign the first task to a first set of users based on the parsed contents of the first assignment template. The processor may be further configured to retrieve a second assignment template of the set of assignment templates, parse the contents of the second assignment template, and assign the first task to a second set of users based on the parsed contents of the second assignment template. The processor can also be configured to retrieve a second task of the set of tasks and automatically assign the second task to the first set of users based on the parsed contents of the first assignment template. The first and second tasks may be linked to indicate relationships between the first and second tasks. The assignment of the first and second tasks to the first set of users may include loading the contents of the first assignment template into the first and second task data structures. The assignment of the first and second tasks to the first set of users can include linking first and second tasks data structures to the first assignment template.

In some embodiments, a computer-readable medium having stored thereon computer-executable components is provided. The medium may store instructions that, in response to execution by a processor of a computing device, cause the computing device to provide a list engine configured to receive a first selection of a plurality of assignees to assign to a task, receive a second selection of corresponding responsibilities for each of the assignees, and store the first and second selections in an assignment template; and a task engine configured to retrieve the assignment template from storage and automatically assign the plurality of assignees with their corresponding responsibilities to a first task based on selection of the assignment template. The task engine may assign the plurality of assignees by parsing the contents of the assignment template and loading the contents into the first task. In addition, the task engine may assign the plurality of assignees by linking the assignment template to the first task. The selection of the assignment template may be determined by a default setting selected by an organization or an individual.

The plurality of assignees of the first assignment template may include a second assignment template. The second assignment template may be linked to the first assignment template. The task engine may assign a subset of the plurality of assignees to the first task based on input from a user. Additionally, the task engine may retrieve a second assignment template from storage and automatically assign a second plurality of assignees with their corresponding responsibilities to the first task based on selection of the second assignment template.

Advantages and features of the disclosure in part may become apparent in the description that follows and in part may become apparent to those having ordinary skill in the art upon examination of the following or may be learned from practice of the disclosure. The advantages and features of embodiments of the present disclosure may be realized and attained by the structures and processes described in the written description, the claims, and in the appended drawings.

It is to be understood that both the foregoing general description and the following detailed description are exemplary and explanatory, and should not be construed as limiting the scope of the claims.

### DESCRIPTION OF THE DRAWINGS

The accompanying drawings are included to provide a further understanding of the disclosure, and are incorporated herein and constitute a part of this application. The drawings together with the description serve to explain exemplary embodiments of the present disclosure. In the drawings:

FIG. 1 illustrates a block diagram of an exemplary system capable of managing tasks, according to various aspects of the disclosure;

FIG. 2 illustrates routines performed by exemplary components of a management device, according to various aspects of the disclosure;

FIGS. 3-4 illustrate routines and actions performed by exemplary components of a management device, according to various aspects of the disclosure; and

FIG. 5 illustrates a flow diagram of task distribution performed by exemplary components of the system of FIG. 1, according to various aspects of the disclosure.

### DETAILED DESCRIPTION

The present disclosure relates to management of information and relationships. In some embodiments, a management device is configured to optimize the assignment of tasks, activities, or workflows. In contrast to existing systems in which task distribution can be inefficient, the management device may create assignment templates of task assignees that include levels of responsibilities for each of the assignees. Based on the assignment templates, the management device may then automatically delegate tasks to particular individuals, groups, or organizations.

Reference will now be made in detail to the specific embodiments of the present disclosure, examples of which are illustrated in the accompanying drawings. Wherever possible, the same reference numbers will be used throughout the drawings to refer to the same or like parts.

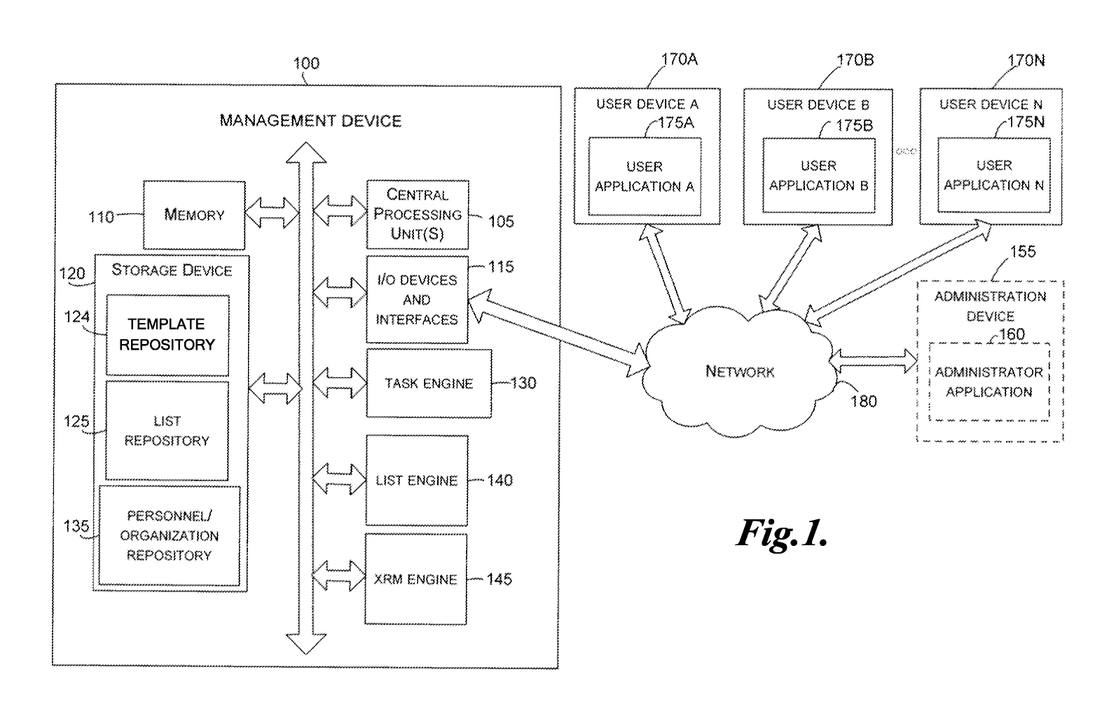

FIG. 1 illustrates a block diagram of an exemplary system configured to manage tasks. As shown, a management device 100 communicates with an optional administration device 155, user devices 170A, 170B, and 170N (representative of any number of user devices), and/or other devices over a network 180. Communication within the system may take place over network 180 using sockets, ports, and/or other mechanisms known in the art. The communication may also be via wires, wireless technologies, cables, or other digital or analog techniques and devices to perform those techniques over a local area network (LAN), wide area network (WAN), or the internet, for example. Management device 100, administration device 155, user devices 170A-N, and/or other devices may be a computing system, such as one or more computer servers or one or more computing devices communicatively coupled in a peer-to-peer architecture. Of note, management device 100, administration device 155, user devices 170A-N, and/or other devices may reside on physically separate machines, such as computers, or be on the same machine. In addition, the illustrated system and devices may be configured to operate in local, remote, or cloud computing environments.

User devices 170A-N may include user applications 175A-N that allow the user to transmit information back and forth to management device 100. User applications 175A-N may include an application running in a web environment, an electronic mail server, and/or a native application that interfaces with task engine 130, list engine 140, or XRM engine 145, such as a web browser, electronic mail client, or native application that runs on user devices 170A-N. In addition, user applications 175A-N help allow the user to create, modify, update, or delete assignment templates and tasks, as well as assign assignment templates to tasks.

Management device 100, and other computing devices shown, may include one or more central processing units (CPUs) 105 and a memory 110, such as random access memory (RAM), to store information temporarily or permanently. Management device 100 may also include one or more input/output (I/O) devices and interfaces 115, such as a network interface or card, keyboard, and/or the like to receive or transmit data. Management device 100, and other computing devices shown, may further include a computer-readable storage device 120, such as one or more hard drives and/or the like. The storage device 120 includes one or more data repositories having a variety of structured or unstructured content, such as file systems or databases. Components of management device 100 may be interconnected using a standards-based bus system, such as Peripheral Component Interconnect (PCI), for example.

Management device 100, and other devices shown, may include various operating systems, web servers, and hardware resources, and may operate on different network domains. The operating systems and other computer-executable components, such as task engine 130, list engine 140, XRM engine 145, and/or user applications 175A-N, may manage the various hardware resources and provide a graphical user interface (GUI) through a web server, for example.

As shown, management device 100 and the other devices illustrated, such as administration device 155 and user devices 170A-N, may include one or more engines or applications. In general, an “engine” (used interchangeably with the word application or module), as used herein, is logic embodied in hardware or software instructions, which can be written in a programming language, such as Java™, PHP, Perl, PHP, HTML, CSS, JavaScript, VBScript, ASPX, Microsoft .NET™, and/or entities and workflows within an XRM product, such as Microsoft Dynamics CRM™, for example. A software engine or application can be compiled into executable programs or written in interpreted programming languages. Software engines or applications may be callable from other engines, or from themselves. Generally, the engines or applications described herein refer to logical modules that may be merged with other engines or applications or divided into sub-engines despite their illustrated organization. The engines or applications may be stored in any type of computer-readable medium or computer storage device, and may be executed by one or more general purpose computers. In addition, the methods and processes disclosed herein may alternatively be embodied in one or more engines, applications, or specialized computer hardware.

Management device 100 may include a task engine 130, list engine 140, and XRM engine 145. Task engine 130, list engine 140, and XRM engine 145 may include an application running in a web environment, an electronic mail server, and/or a native application that interfaces with a user application 175A-N, such as a web browser, electronic mail client, or native application that runs on user devices 170A-N. As shown, XRM engine 145 can include any XRM, CRM, or ERP system and the like, such as Microsoft Dynamics CRM™. XRM engine 145 may utilize one or more accompanying XRM or CRM repositories (not shown) that may be stored in storage device 120. In some embodiments, a data structure of the assignment template that configures which organizations and/or individuals may be members of the assignment template may be stored in an XML format in an ntext column in the XRM or CRM repositories. An entity for the assignment template may store the data structure and a type that determines who may view or access the assignment template.

List engine 140 may be configured to enable the creation of assignment templates that can be reused to delegate tasks to various individuals, users, or organizations. Because the process of assigning tasks may involve repeatedly tasking the same persons to perform an activity and/or related activities, list engine 140 may be configured to generate an assignment template that can advantageously allow repeatable assignments to be defined for particular individuals or groups of individuals, including their corresponding responsibility for completing a task. In some embodiments, each assignee, such as an individual, group, organization, etc. along with their respective responsibility level may be assigned a separate task in a tree of related tasks that may be hierarchically related. This can advantageously allow tracking of the progress and performance of each assignee separately and/or simplify report generation, for example.

User applications 175A-N may be configured to allow the user to build the assignment template by asking the user a series of questions and/or allow the user to directly enter information regarding which individuals or groups to include in the list and their level of responsibility. The individuals, groups, etc. may be users of a XRM system, such as Microsoft Dynamics CRM™, reside in a directory, such as Microsoft Active Directory™, etc. Typically these individuals or groups are stored in personnel/organization repository 135 which may be accessed by user application 175A-N via list engine 140 or task engine 130 in order to select task assignees. The level of responsibilities that an individual may have for accomplishing or completing a task may include one of primary responsibility or secondary responsibility. Additionally, the level of responsibilities may be adjustable to include a plurality of levels that may be selected by user applications 175A-N depending on the extent or degree of responsibility to be assigned to an assignee of a particular task. In some embodiments, a level of responsibility may be included that provides the individual assigned to the task copies or notice of the progress of the task, but bears no responsibility for completion of the task.

An assignment template may also be designated as global (e.g., available to all users and all organizations), organizational (e.g., available to users that belong to a particular organization), personal (e.g., available to the user personally), and/or as belonging to particular group of users. The type of assignment template may be stored in the data structure of the assignment template. In addition, based on the type of assignment template, other users, organizations, groups, etc. may edit or delete the assignment template. Additionally, defaults may be set for particular assignment templates such that when a task is created by a certain user, group, or organization, a particular assignment template may be used as the default to assign the new task.

A user application 175A-N may provide a picklist or dropdown through a GUI to allow the user to enter the list information and then transmit the list back to management device 100 in order for list engine 140 to process the list information. Once received, list engine 140 may compile the list information and store it in a format that includes extensible markup language (XML), for example. Once created, an assignment template may be stored in list repository 125. An assignment template may include another assignment template embedded within it, which may simplify maintenance and updating of assignment templates and/or task assignments.

Task engine 130 may be configured to allow the user to create, modify, update, or delete a task, such as an activity or workflow that needs to be completed. Additionally, task engine 130 allows the user to retrieve assignment templates from list repository 125. Once retrieved, user application 175A-N may load the assignment templates and allow the user to select one or more assignment templates to assign users to a set of tasks using a GUI, for example. On the backend, task engine 130 may be configured to retrieve the assignment template, which may be in XML format, parse the assignment template, and apply the appropriate assignments to the task(s). The assignment of task(s) may include linking an assignment template to the task (without any actual copying of the contents) or copying the contents of the assignment template into the task data structure itself. Linking between the assignment template and the task may be advantageous in that it allows dynamic updating of task assignments by merely changing the assignment template itself and not the actual task record. Once the task(s) have been assigned, the updated task(s) may be stored in the task repository 124. At a later time, a user may revise the assignment of the task(s) or an assignment template by using a user application 175A-N as a front end to access the backend task repository 124 and list repository 125 via task engine 130 and list engine 140.

As illustrated, storage device 120 may include task repository 124, list repository 125, and personnel/organization repository 135. Storage device 120 may also include other repositories, such as CRM or XRM repositories (not shown) that may be utilized by XRM engine 145 and/or other engines. Generally, these repositories may be configured to store information related to one or more tasks; assignment templates; and individuals, groups, or organizations, respectively. The repositories and data structures may be configured (e.g., created, deleted, updated, modified) by a system administrator using an administrator application 160 on administration device 155. Administrator device 155 may communicate with management device 100 which includes the various repositories, task engine 130, list engine 140, and XRM engine 145.

An administrator may control user access to the management device 100 using, for example, administration device 155. Administration device 155 may be located separately from the management device 100 and user devices 170A-N. Using administration device 155, the administrator may, for example, limit the individuals or groups which a certain user may assign to an assignment template or task. The administrator may have direct access to the management device 100, or may provide administration via network 180 using administration device 155 to manage the assignment template creation options and task assignment options available to users at user devices 170A-N or to control the available configurations at the management device 100.

In exemplary embodiments, administrator application 160 of administration device 155 may be used for management of the assignment templates. For example, although a user application 175A-N may be able to create a type of assignment template that may be available to a user personally, available to an organization, and/or available globally, an administrator application 160 can be used to set security permissions and/or restrictions for the users to limit that capability. For example, administrator application 160 may be used to restrict certain users from creating organizational or global assignment templates. Administrator application 160 may itself be used to create globally available assignment templates.

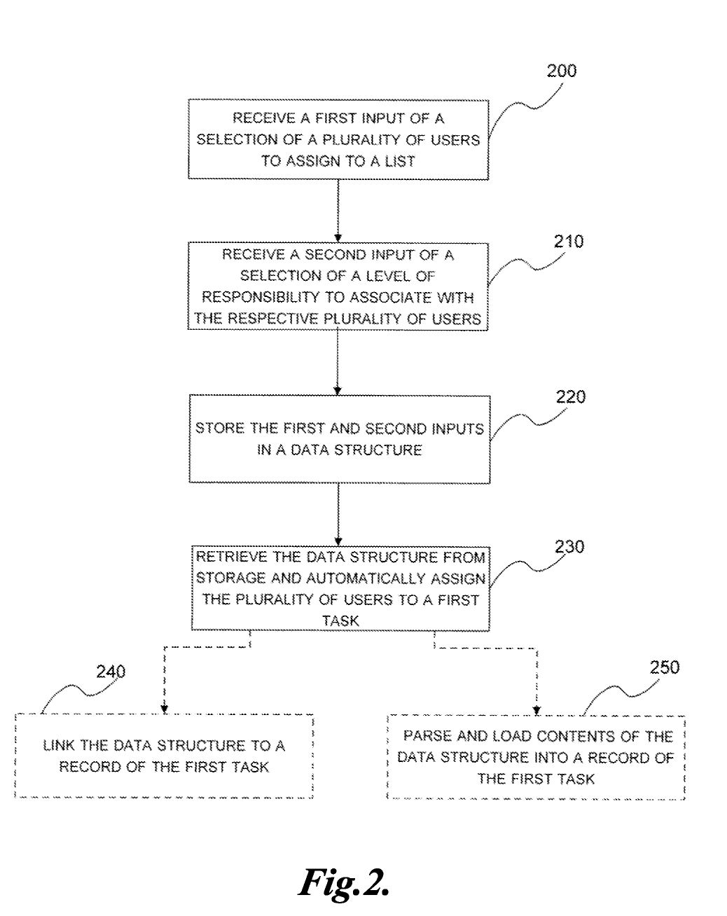

FIG. 2 illustrates exemplary routines which components of a management device 100 are configured to perform. In some embodiments, these routines may be performed by task engine 130, list engine 140, and XRM engine 145 of management device 100, and may use task repository 124, list repository 125, and personnel/organization repository 135. Depending on the embodiment, the method of FIG. 2 may include fewer or additional blocks, and blocks may be performed in an order which may be different than illustrated.

Beginning in block 200, a first input of a selection of a plurality of users may be received. The first input may be selected using a picklist or dropdown interface directly at the management device 100, or may be transmitted from a user device 170A-N where a system user made a selection via a user application 175A-N. The selected plurality of users may include individuals, groups, or organizations to place on an assignment template. The first input may be received in any format or protocol, including but not limited to: electronic mail, simple network management protocol (SNMP), extensible markup language (XML), hypertext transport protocol (HTTP) (e.g., using HTTP POST), secure socket layer (SSL), syslog server, secure syslog, remote copy (rcp), secure copy (scp), file transfer protocol (FTP), secure file transfer protocol (SFTP), various application programming interfaces (APIs), and/or the like.

Moving to block 210, a second input of a level of responsibility to associate with the respective plurality of users may be received. The second input may be selected using a picklist or dropdown interface directly at the management device 100 or transmitted from a user device 170A-N where a system user made a selection via a user application 175A-N. The selected level of responsibility may include values of primary, secondary, and/or tertiary responsibility, etc. The second input may be received using the formats or protocols described with respect to block 200.

At block 220, the first and second inputs may be stored in a data structure, such as an assignment template. In exemplary embodiments, list engine 140 may parse contents of the first and second inputs and structure the information contained therein such that each member (e.g., individual, group, or organization) of the first input may be associated with its respective responsibility level. The data structure may be in a XML language format, for example. This may advantageously improve portability and compatibility among different systems.

Continuing to block 230, the data structure may be retrieved from storage and the plurality of users may be automatically assigned to a first task. The data structure for the assignment template may also be assigned to multiple tasks simultaneously and/or multiple assignment templates may be assigned to a single task and/or multiple tasks. For example, a user may select an option that allows tasks that may be related to the first task (e.g., parents or children that may be linked together) to also have the same or a similar assignment template. The reuse of the assignment template when assigning tasks may greatly reduce the manual work needed to create, manage, and delegate tasks in corporate, enterprise, organizational, government, and military environments by providing increased computer automation. As shown in block 240, the assignment step may optionally include linking the data structure, such as the assignment template, to a record of the first task using a pointer or other reference (e.g., memory location, disk location, file location, unique identifier, database key etc.). Alternatively, as shown in block 250, the contents of the data structure may optionally be loaded or copied directly into the first task itself (e.g., a record storing the first task).

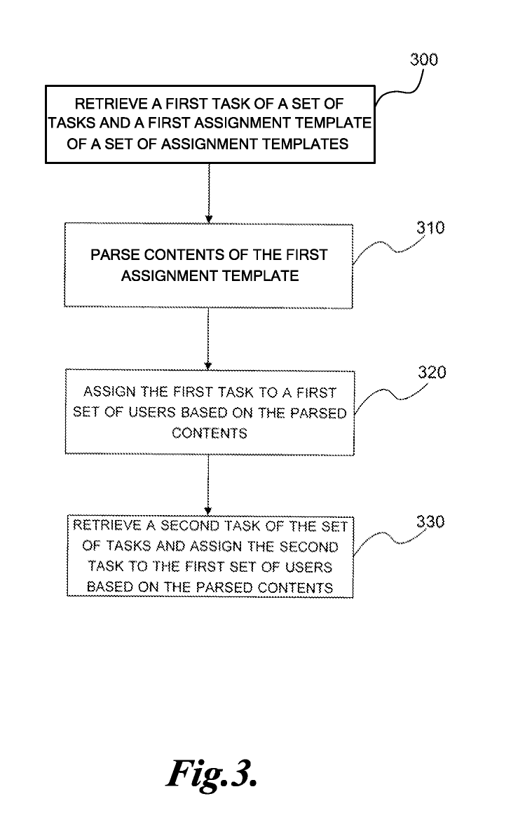

FIG. 3 illustrates further exemplary routines and actions which embodiments of a management device 100 are configured to perform. The exemplary routines may be stored as computer-executable instructions accessible by task engine 130, list engine 140, and XRM engine 145 of management device 100, and may use task repository 124, list repository 125, and personnel/organization repository 135. Depending on the embodiment, some of the blocks described below can be removed, others may be added, and/or the sequence of the blocks may be different.

Beginning in block 300, a first task of a set of tasks and a first assignment template of a set of assignment templates may be retrieved. Moving to block 310, contents of the first assignment template may be parsed. In one embodiment, when the first assignment template is stored in XML format, an XML querying language such as XQuery or an XML parser may be used to extract information from the assignment template data structure.

Continuing to block 320, after parsing the contents of the first assignment template, the first task may be assigned to a first set of users based on the parsed contents. For example, the first assignment template may designate the following assignees: a first set of individuals (e.g., A, B, C), groups of individuals (e.g., D, E, F), and/or organizations (e.g., G, H, I). Based on the designation of assignees, the first task may then be assigned to all, a subset, or superset of the foregoing assignees. In one embodiment, when all of the foregoing assignees are automatically loaded into the first task record with their corresponding responsibilities, the system user may then delete some or all of the assignees and/or add additional assignees using a user application 175A-N via task engine 130, for example. This may occur when the first assignment template is a default assignment template for the system user, an organization to which the system user belongs, a group to which the system user belongs, and/or the like. In some embodiments, the system user may further select a box that allows tasks related to the first task to automatically be assigned to the first assignment template as well.

Moving to block 330, a second task of the set of tasks may be retrieved and assigned to the first set of users based on the parsed contents. In one embodiment, in response to this occurrence, the first assignment template may be linked by a reference or a pointer to both the first and second tasks. In another embodiment, the contents of the first assignment template may be copied directly into the first and second task data structures.

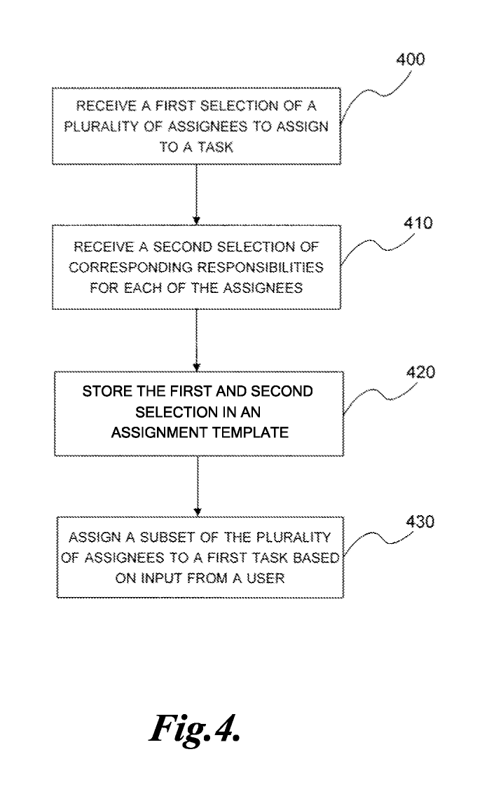

FIG. 4 illustrates routines and actions which exemplary components of a management device 100 are configured to perform. The exemplary routines may be stored as computer-executable instructions accessible by task engine 130, list engine 140, and XRM engine 145 of management device 100, and may use task repository 124, list repository 125, and personnel/organization repository 135. Depending on the embodiment, the method of FIG. 4 may include fewer or additional blocks, and blocks may be performed in an order that may be different than illustrated.

Beginning in block 400, a first selection of a plurality of assignees to assign to a task may be received. Moving to block 410, a second selection of corresponding responsibilities for each of the assignees may be received. Management device 100 may receive the first and second selections from a user application 175A-N at a user device 170A-N.

At block 420, the first and second selections may be stored in an assignment template. In some embodiments, the first and second selections may be parsed by list engine 140 and then stored in a data structure of the assignment template. Continuing to block 430, a subset of the plurality of assignees may be assigned to a first task based on input from a user. In the illustrated embodiments, for example, a user may select a subset of the assignees using a picklist interface or dropdown box. Alternatively, policies and/or default configuration settings for a particular individual, group, organization, enterprise, etc. may dictate a particular subset to be selected automatically from the plurality of assignees. The policies and/or settings may be set by the individual or organization to which the user belongs, for example.

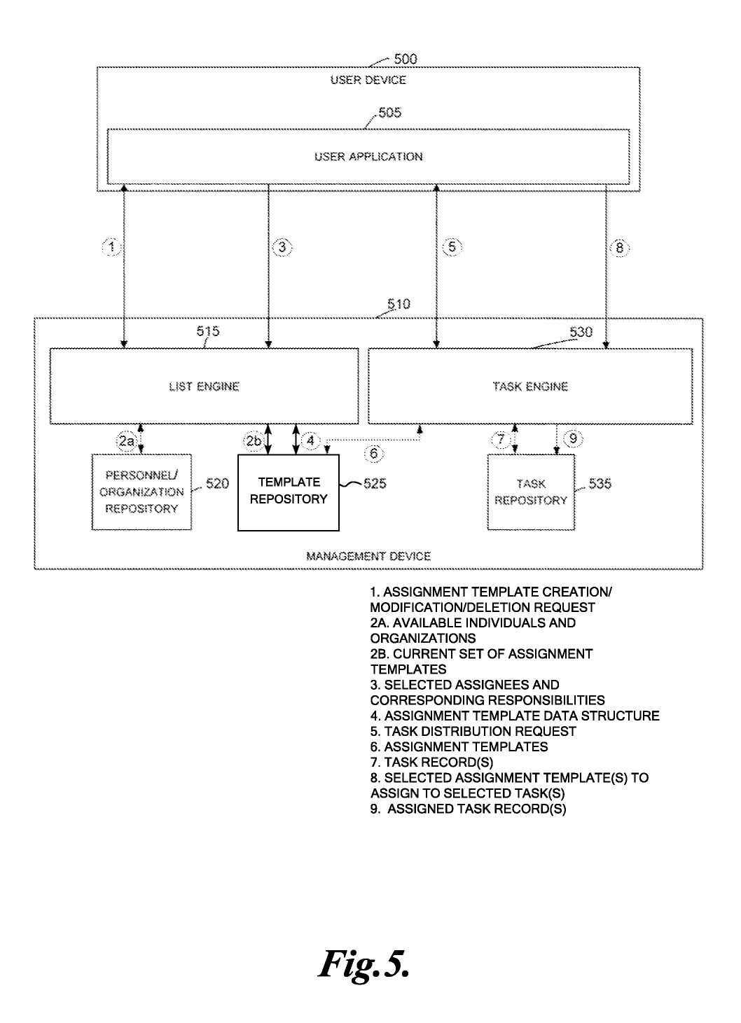

FIG. 5 illustrates a flow diagram of one embodiment of a method of task distribution which exemplary components of the system of FIG. 1 are configured to perform. In some embodiments, the illustrated routines may be performed by task engine 130, list engine 140, and XRM engine 145 of management device 100, and may use task repository 124, list repository 125, personnel/organization repository 135, and various components of these devices. Depending on the embodiment, the method of FIG. 5 may include fewer or additional blocks, and blocks may be performed in an order different than illustrated.

Beginning in step 1, user application 505 of user device 500 may send a request to list engine 515 of management device 510 to create, modify, or delete an assignment template. In some embodiments, modifying an assignment template may not modify task assignments to which the assignment template has been previously assigned. Alternatively, modifying the assignment template may modify task assignments to which the assignment template has been previously assigned. Moving to step 2a, list engine 515 may query personnel/organization repository 520 in order to retrieve a list of individuals, organizations, etc. that may be potential assignees for tasks in the system. Continuing to step 2b, list engine 515 may query list repository 525 to obtain a current set of assignment templates. Returning to step 1, the list of potential assignees and set of assignment templates may be returned to the user application 505.

Moving to step 3, a user via user application 505 may select assignees and their corresponding responsibilities for creating and updating an assignment template, and may transmit this information to list engine 515. At step 4, after compiling this information into a new assignment template data structure or updating an already existing assignment template data structure, list engine 515 may store the assignment template in list repository 525.

Continuing to step 5, user application 505 may send a request to task engine 530 of management device 510 to use an assignment template as a template to distribute task(s) to various assignees. At step 6, task engine 530 may query the list repository 525 to retrieve a set of assignment templates. Continuing to step 7, task engine 530 may then query task repository 535 to obtain a current set of tasks. Returning to step 5, the current set of assignment templates and tasks may be returned to user application 505.

Moving to step 8, user application 505 may select one or more assignment templates to assign to one or more tasks and transmit the selection to task engine 530. At step 9, task engine 530 may then assign the selected assignment template(s) to the selected task(s). Step 9 may include updating the selected task(s) in the task repository 535 to include assignees from the selected assignment template(s) and/or linking the selected task(s) to the selected assignment template(s).

It will be apparent to those skilled in the art that various modifications and variations can be made in the present disclosure without departing from the spirit or scope of the disclosure. Thus, it is intended that the present disclosure cover any modifications and variations within the scope of the appended claims and their equivalents.

The embodiments of the invention in which an exclusive property or privilege is claimed are defined as follows:

1. A computer-implemented method, comprising:
receiving, by a computer, a selection of a plurality of users to assign to a list as a first input;
receiving, by a computer, a selection of a level of responsibility to associate with the respective plurality of users as a second input; and
storing the first and second inputs in a data structure.

2. The method of claim 1, further comprising linking the data structure to a plurality of tasks.

3. The method of claim 2, wherein the plurality of tasks comprise activities to be completed by a group of individuals or organizations.

4. The method of claim 1, further comprising retrieving the data structure from storage and automatically assigning the plurality of users to a first task with the associated level of responsibility based on the data structure.

5. The method of claim 4, wherein the assigning comprises linking the data structure to a record of the first task.

6. The method of claim 5, further comprising linking the data structure to a record of a second task.

7. The method of claim 4, wherein the assigning comprises loading contents of the data structure into a record of the first task.

8. The method of claim 1, wherein the data structure is stored in a format including extensible markup language.

9. The method of claim 1, wherein the level of responsibility comprises a first level of primary responsibility or a second level of secondary responsibility.

10. The method of claim 1, wherein the users comprise an organization and an individual.

11. A computing device comprising:
a computer-readable storage medium configured to store a set of tasks and a set of assignment templates; and
a processor configured to retrieve a first task of the set of tasks and a first assignment template of the set of assignment templates, parse contents of the first assignment template, and assign the first task to a first set of users based on the parsed contents of the first assignment template.

12. The device of claim 11, wherein the processor is further configured to retrieve a second assignment template of the set of assignment templates, parse contents of the second assignment template, and assign the first task to a second set of users based on the parsed contents of the second assignment template.

13. The device of claim 11, wherein the processor is further configured to automatically retrieve a second task of the set of tasks, and to assign the second task to the first set of users based on the parsed contents of the first assignment template, wherein the first and second tasks are linked to indicate a relationship between the first and second tasks.

14. The device of claim 13, wherein the assignment of the first and second tasks to the first set of users comprises loading contents of the first assignment template into the first and second task data structures.

15. The device of claim 13, wherein the assignment of the first and second tasks to the first set of users comprises linking first and second tasks data structures to the first assignment template.

16. The method of claim 11, wherein the assignment template is stored in an extensible markup language format.

17. A computer-readable medium having stored thereon computer-executable components that, in response to execution by one or more processors of a computing device, cause the computing device to provide:
a list engine configured to receive a first selection of a plurality of assignees to assign to a task, receive a second selection of corresponding responsibilities for each of the assignees, and store the first and second selections in an assignment template; and
a task engine configured to retrieve the assignment template from storage and automatically assign the plurality of assignees with their corresponding responsibilities to a first task based on selection of the assignment template.

18. The computer-readable medium of claim 17, wherein the task engine is further configured to assign the plurality of assignees by parsing contents of the assignment template and to load the contents into the first task.

19. The computer-readable medium of claim 17, wherein the task engine is further configured to assign the plurality of assignees by linking the assignment template to the first task.

20. The computer-readable medium of claim 17, wherein the plurality of assignees of the first assignment template comprises a second assignment template.

21. The computer-readable medium of claim 20, wherein the second assignment template is linked to the first assignment template.

22. The computer-readable medium of claim 17, wherein the task engine is further configured to assign a subset of the plurality of assignees to the first task based on input from a user.

23. The computer-readable medium of claim 17, wherein the task engine is configured to retrieve a second assignment template from storage and to automatically assign a second plurality of assignees with their corresponding responsibilities to the first task based on selection of the second assignment template.

24. The computer readable medium of claim 17, wherein the selection of the assignment template is determined by a default setting selected by an organization.

25. The computer readable medium of claim 17, wherein the selection of the assignment template is determined by a default setting selected by an individual.
